(19) United States
(12) Patent Application Publication
(10) Pub. No.: US 2023/0165406 A1
(43) Pub. Date: Jun. 1, 2023

(54) Herb Crusher

(71) Applicant: Gilbert Morales, El Paso, TX (US)

(72) Inventor: Gilbert Morales, El Paso, TX (US)

(21) Appl. No.: 17/803,345

(22) Filed: May 23, 2022

Related U.S. Application Data
(60) Provisional application No. 63/258,764, filed on May 26, 2021.

(51) Int. Cl. A47J 42/34; B02C 19/20; A47J 42/14

(52) U.S. Cl. CPC A47J 42/34; B02C 19/20; A47J 42/14

(57) ABSTRACT

A rotatable herb crusher comprising a top cap, grinder section, upper middle section, lower middles section and a bottom cap.

### BACKGROUND OF THE INVENTION

### 1. Field of the Invention

This invention relates to an herb crusher, specifically a grinder for Cannabis more commonly referred to as marijuana.

### 2. Description of the Prior Art

In its natural state, herbs, such as Cannabis, exist generally in a form that must be ground up before being used. Specifically, with marijuana, the leaf and/or buds must be ground up to a particle size that will permit the best experience when smoked as a joint. If the particle size of the ground up marijuana is too large, rolling a joint will become difficult. If the particle size is too small, the rolled joint may be too dense for enjoyable smoking.

It is also common that when a person grinds the marijuana, they take the Cannabis from one container where the marijuana is stored, and place such material in a grinder. Transferring the marijuana from the container to the grinder generally results in material being spilled onto the ground or floor.

### SUMMARY OF THE INVENTION

It is, therefore, an object of the present invention to provide an herb or Cannabis grinder that will produce the proper particle size for the best smoking experience. It is also the object of this invention to provide a grinder that includes a storage compartment Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is an exploded view of the five parts to the herb crusher of the present invention.

FIG. 2 is a top, side and bottom view of the top cap of the present invention.

FIG. 3 is a top, side and bottom view of the bottom cap of the present invention.

FIG. 4 is a top, side and bottom view of the grinder of the present invention.

FIG. 5 is a top, side and bottom view of the upper middle section of the present invention.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

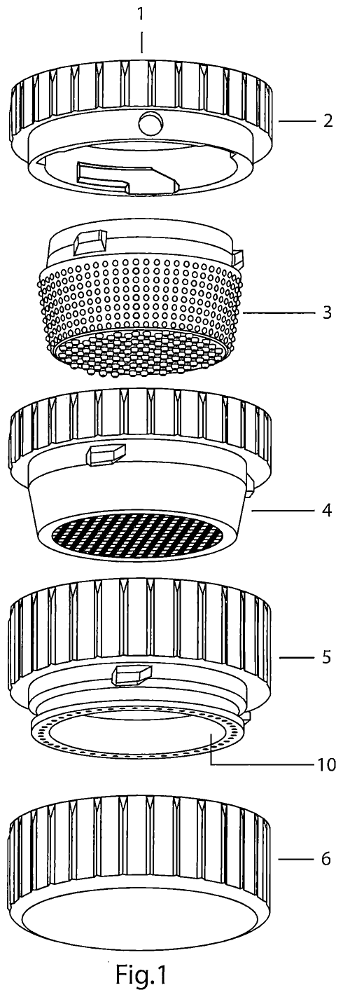

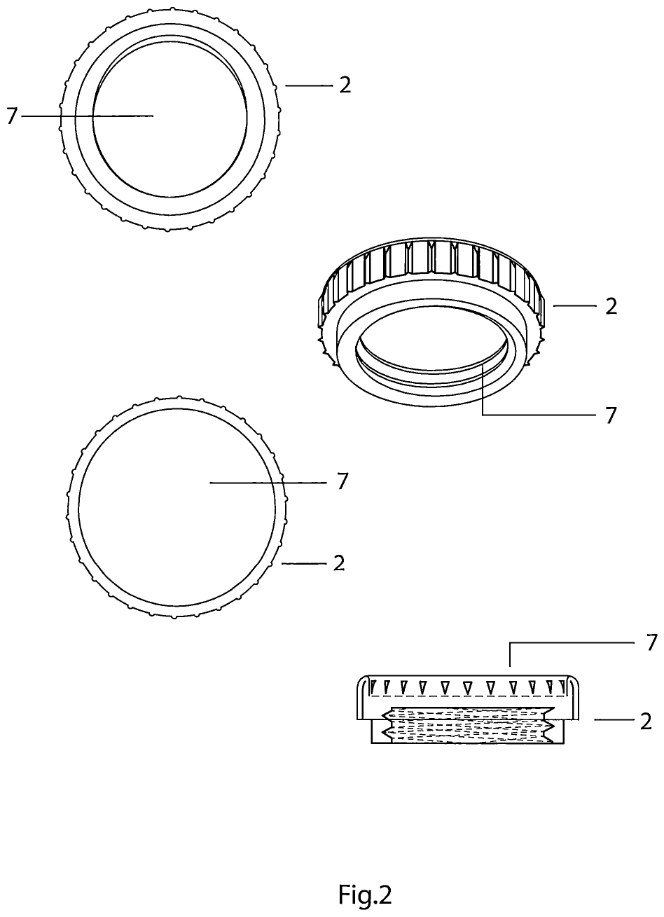

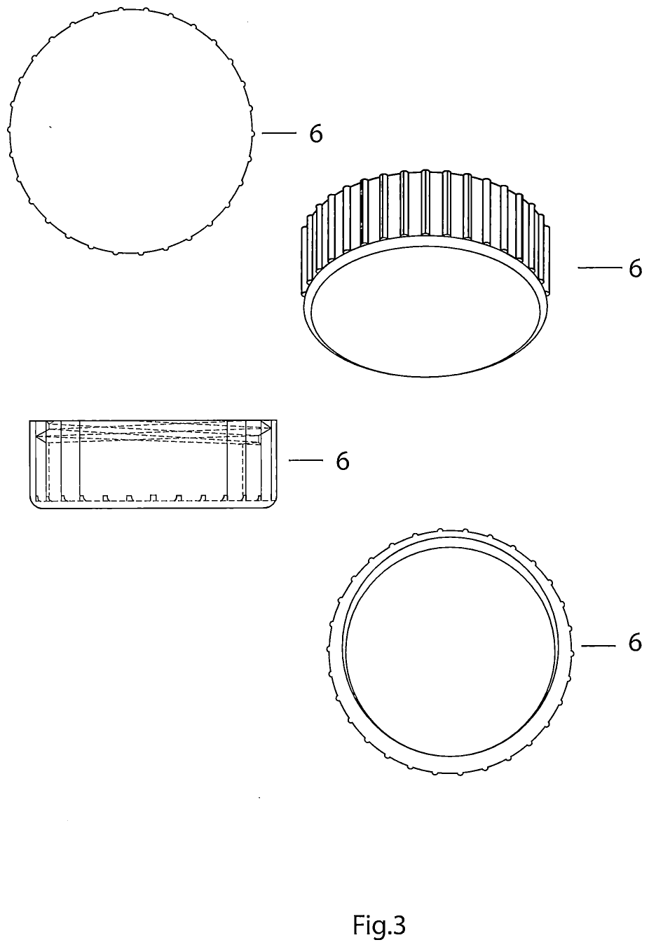

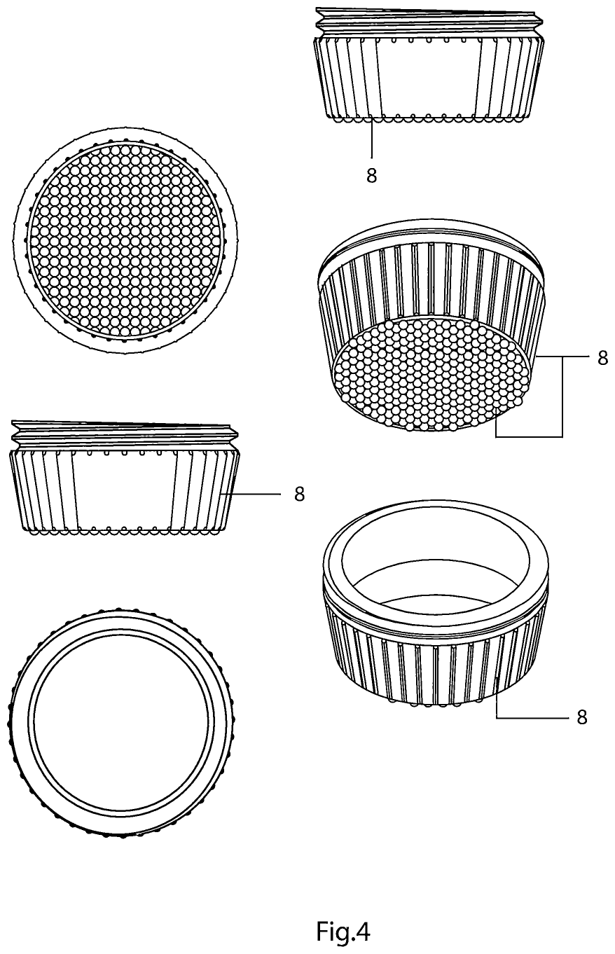

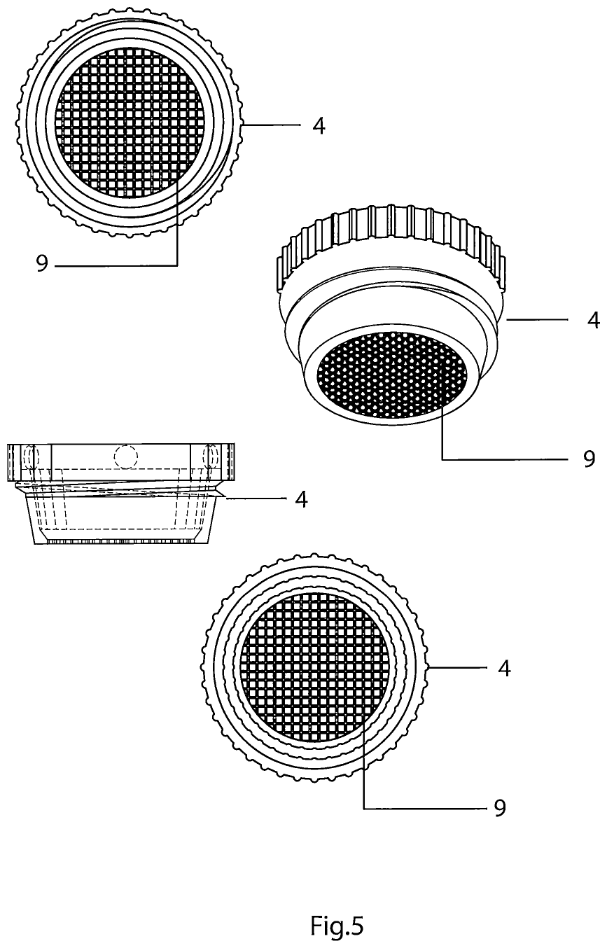

As can be seen in FIGS. 1-5, the grinder [1] of the present invention comprises five different parts; the top cap [2], the grinder section [3], the upper middle section [4], lower middle section [5] and the bottom cap [6]. Although the top cap [2] of the present invention can be secured to the grinder section [3] using any conventional means such as threads, the present invention utilizes a series of locking tabs located on the grinder section [3] which interlock with openings located on the top cap [2] when rotated together. While the top cap/grinder assembly could be of one piece construction, the two piece assembly of the present invention allows for a storage compartment [7] between the top cap [2] and the inside of the grinder section [3]. The grinder section [3] includes a series of raised surfaces [8] along the side and bottom outside surfaces which will contact the herb to be crushed. The raised surfaces [8] are sized and numbered to produce the desired particle size of the crushed herb. The top cap/grinder assembly is of sufficient size to fit securely within the upper middle section [4] but which will allow rotation of the top cap/grinder assembly within said section. The upper middle section [4] includes a bottom screen surface [9] with openings of sufficient size to allow for the properly ground up herb to pass from the upper middle section [4] into the lower middle section [5]. The bottom cap [6] is secured to the lower middle section [5] using the same type of locking tabs of the that used to secure the top cap [2] to the grinder section [3]. Although not necessary to the operation of the herb crusher of the present invention, the lower middle section [5] can also include a screen bottom surface [10] with openings of sufficient size to allow for non desired fine herb particles to pass from the lower middle section [5] into the bottom cap [6].

In use, the top cap [2] is removed from the grinder section [3]. Marijuana or other herb is taken from the storage compartment [7] and placed into the grinder section [3]. The top cap [2] is then secured tp the grinder section [3] and said section is rotated within the upper middle section [4]. Ground up herb falls from the grinder section [4] through the screen [9] into the lower middle section [5]. Undesired fine particles fall through the screen [10] of the lower middle section [5] into the bottom cap [6]. Herb or marijuana of desired particle size is then removed from the lower middle section [5].

The herb crusher of the present invention can be made of any type of material with sufficient rigidity to allow function such as plastic, wood, or metal. The mesh sizes and/or screen sizes utilized can be varied from grinder to grinder depending upon the particle size desired. Handles can be placed on the top cap [2] to help with the rotation of the grinder section [3]. The overall size of the herb crusher [1] of the present invention can be increased or decreased depending upon what an individual user desires but is generally a size that would fit comfortably within a person's hand.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A rotatable herb crusher comprising a top cap, grinder section, upper middle section lower middle section and bottom cap.

2. The rotatable herb crusher of claim 1 wherein the outside side and bottom surfaces include raised surfaces for contact with the herb to be crushed.

3. The rotatable herb crusher of claim 1 wherein the bottom surface of the upper middle section contains opening for flow of crushed herb from the grinder section into the lower middle section.

4. The rotatable herb crusher of claim 1 wherein the grinder section has at least 2 tabs which interlock with matching openings on the top cap.

5. The rotatable herb crusher of claim 1 wherein the grinder section includes a storage compartment.

6. The rotatable herb crusher of claim 1 wherein the upper middle section has at least 2 tabs which interlock with matching openings on the lower middle section.

7. The rotatable herb crusher of claim 1 wherein the lower middle section has at least 2 tabs which interlock with matching openings on the bottom cap.

8. The rotatable herb crusher of claim 1 wherein the bottom cap includes a storage compartment.

9. The rotatable herb crusher of claim 1 wherein the bottom surface of the lower middle section includes openings for fine particles to pass from the lower middle section into the bottom cap.

10. A method of using a rotatable herb crusher comprising a top cap, grinder section, upper middle section lower middle section and bottom cap comprising the steps of:
a. rotating the top cap of said crusher onto the grinder section to a locked position;
b. placing an amount of herb to be crushed into the upper middle section;
c. securing the grinder section with top cap to the lower middle section;
d. securing the bottom cap to the lower middle section;
e. rotating the top cap/grinder assembly within said upper middle section until desired particle size distribution is achieved;
f. removing the lower middle section from the upper middle section and extricating the ground herb from the lower middle section.
